(19) United States
(12) Patent Application Publication
(10) Pub. No.: US 2009/0067776 A1
(43) Pub. Date: Mar. 12, 2009

(54) OPTICAL FIBERS

(75) Inventors: Rogerio Tadeu Ramos, Eastleigh (GB); Gregory H. Manke, Overland Park, KS (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/853,420

(22) Filed: Sep. 11, 2007

(51) Int. Cl. G02B 6/44; C03B 37/028

(52) U.S. Cl. 385/12; 385/107; 65/412

(57) ABSTRACT

One or more silica optical fibers (22), especially for use in downhole distributed temperature sensing and similar applications, are deployed in a corrosion resistant metal alloy control line (20) which is electrically insulated with, for example, EPDM. The insulation layer may be covered by a fluid resistant sealing layer (26), which may in turn be covered by a mechanical armor layer 28. The resultant composite optical fiber cable exhibits improved resistance to degradation of optical performance at elevated temperatures over about 100 deg. C.

### FIELD OF THE INVENTION

This invention concerns optical fibers, and in particular relates to a method of reducing the rate at which the optical properties of an optical fiber degrade in an elevated temperature environment, and to an optical fiber cable with enhanced stability against such degradation.

### BACKGROUND OF THE INVENTION

It is been known for some time that optical fibers can be used as temperature and pressure transducers, and particularly as distributed temperature sensors. Optical fibers may also be used in other sensing systems measuring other parameters, including acoustic and motion measurement systems. These abilities are exploited in a number of technologies, and particularly for making downhole measurements in oil and gas fields or for monitoring temperature in other remote and difficult to access locations including boreholes and tunnels of all kinds.

When used for temperature and pressure monitoring, optical fibers, which are likely to be of glass, based on silica, are typically deployed in metal tubes for protection. The tubes in which they are deployed are commonly referred to in the art as control lines, since they are essentially similar to the tubing used for hydraulic control lines in downhole applications in the oilfield services industry.

In oil and gas fields, fiber optic based distributed temperature measurement systems can extend for up to 30 km. Frequently a control line will include two or more fibers, for different purposes. While it is possible to manufacture control lines with the fibers installed, it is generally preferable to form the tubing of the control line first, and to place the fiber in the tubing afterwards. This is typically achieved by pumping a fluid through the tube, and using the drag effect of the fluid flow to take a fiber off a reel and carry it through the line as far as may be required. For convenience, a return loop may be included at the remote end of a control line so that a fiber can be pumped down a well through one line and back to the surface through a second parallel line in one continuous loop of fiber which after deployment has two ends each accessible at the wellhead.

Control lines are typically deployed in a well taking advantage of support provided by fixed parts of the completion. It is often convenient to clamp the control line to the outside of steel production tubing.

Normally, distributed temperature measurement systems have a long life. They typically operate in oil and gas wells at temperatures up to not more than about 100° C. It has been found that in wells working at elevated temperatures, the performance of the optical fiber may quickly degrade at a significantly accelerated rate, leading to an unacceptable decline in performance and an early requirement to replace the fiber, with considerable inconvenience and interruption to normal well operations. The temperatures in some wells which rely on thermal recovery methods can reach 300° C. Examples of such wells are those using steam assisted gravity drainage (SAGD) for the extraction of bituminous hydrocarbon reserves. Elevated temperatures in the context of this invention may be considered to be temperatures above about 100° C. and typically above about 150° C.

### SUMMARY OF THE INVENTION

This invention addresses the rate of degradation of optical performance of fibers in elevated temperature environments and seeks to mitigate the problems caused thereby.

According to one aspect of the invention there is provided a method of reducing the rate of optical degradation of an optical fiber deployed within a metal tube in an elevated temperature environment, which comprises electrically insulating a region of the tube that is to contain the fiber and be exposed to elevated temperature, and deploying the fiber in the tube in the elevated temperature environment.

A further aspect of the invention provides an optical fiber cable comprising a bundle of substantially parallel metal tubes, at least one optical fiber deployed within each tube, and electrical insulation covering a substantial length of each tube containing the optical fiber.

In another aspect of the invention an optical fiber cable comprises a metal tube, at least one optical fiber deployed within the tube, electrical insulation covering a substantial length of the tube containing the fiber, and a protective sheath over the electrical insulation.

It will be seen that a common feature of these aspects of the invention is the provision of electrical insulation around the metal tube containing the optical fiber. It is considered that this has an unexpected beneficial effect on the optical performance of the fiber in an elevated temperature environment.

Without intending to be bound by any mechanism or theory, it is believed that insulating the tube carrying the optical fiber prevents or substantially diminishes the opportunities for electrical contact between the tube and other metallic conductors external to the tube. In normal circumstances, this would be of little consequence. But we have found that the effects of elevating temperature can seriously compromise the longevity of the optical fiber, and that electrically insulating the control line from its environment has beneficial consequences in mitigating these deleterious effects.

Control lines used in downhole applications are normally made of corrosion resistant alloy. Various such alloys are used in oilfield installations. They tend to be alloys with high proportions of metals other than iron, including chromium and nickel in particular. While one purpose of the control line is to provide means for deployment of the optical fiber over distances of thousands of meters by transporting it through the internal capillary bore entrained in a flow of pumped fluid, a second purpose is to provide physical protection between the fiber and the aggressive downhole environment. Corrosion resistance is generally beneficial in order to ensure a long working life for the tube once it has been installed in a borehole.

However, the specialist alloys used for these components of the well completion have different compositions from most other metal components in that environment. For example, production of tubing is likely to be made of a regular grade of steel. Metals of different alloy compositions have different electrochemical properties. Accordingly, when placed in electrical contact in a suitable environment, the difference in electrochemical potential between the different metals can be realized as chemical activity. In respect of the optical fibers deployed along a control line, this activity will of course be external to the control line and would not be expected to influence the condition of the fiber internally of the control line.

However, our studies indicate that in elevated temperature environments, electrically conductive contact between control lines and dissimilar metals can result in remarkable and unexpected increases in the generation and diffusion of molecular hydrogen into the interior of the fiber carrying tubes, with consequent deleterious effects, both reversible and irreversible, on the optical properties of the glass. As a result of increased attenuation in the optical fiber, the performance of downhole temperature sensing systems used for monitoring the thermal profile of a well and the temperature of equipment within the well is substantially decreased, affecting reliability and limiting runtimes.

Control lines have incidentally been simply enclosed in the past for mechanical reasons, but not for the purpose of suppressing electrochemical corrosion leading to hydrogen diffusion and optical degradation of optical fibers and elevated temperatures.

In accordance with the invention, the electrical insulation is preferably further protected against hostile environments by means of a protective sheath. This sheath may comprise a fluid resistant sealing layer over the electrical insulation. The sheath may also comprise a mechanical armor, generally on the outermost layer of the fiber optic cable. In a particularly preferred embodiment, the sheath comprises a fluid resistant sealing layer over the electrical insulation and a mechanical armor over the sealing layer.

### BRIEF DESCRIPTION OF THE DRAWINGS

The invention is illustrated by way of non-limiting example in the accompanying drawings, in which:

FIG. 1 is a diagrammatic indication of a short section of a well bore illustrating an environment in which the invention can be utilized;

FIG. 2 is a perspective view diagrammatically illustrating the construction of a first fiber optic cable in accordance with the invention;

FIG. 3 is a perspective view illustrating the construction of a second fiber optic cable in accordance with the invention; and

FIG. 4 is a plot of optical attenuation against wavelength in a silica fiber illustrating the benefit of the invention.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

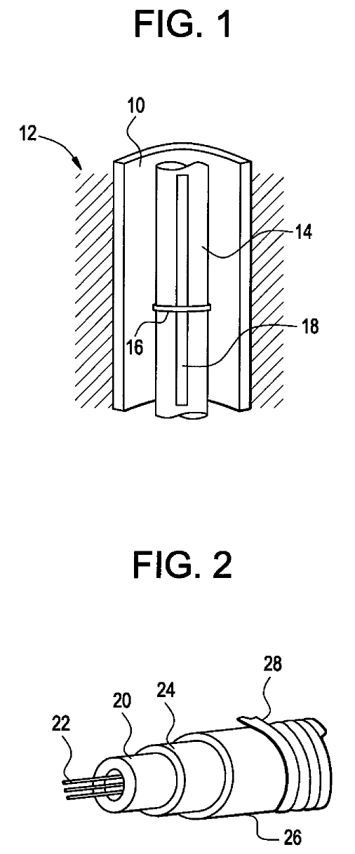

FIG. 1 of the accompanying drawings illustrates a short length of what in practice is an extremely long well bore lined by a casing 10 defining a generally cylindrical bore through a surrounding geological formation 12. Within the casing, and supported and spaced from it by suitable packers (not shown) runs production tubing 14. A plurality of clamping bands 16 are spaced apart along a production tubing, one only being shown in FIG. 1, and these support a variety of service cables and conduits against the outside of the production tubing. Among these is a fiber optic cable 18 in accordance with the invention.

FIG. 1 illustrates a typical environment through which the fiber optic cable runs. The particular section of the well bore might be substantially vertical or might deviate from the vertical as far as substantially horizontal. Typical temperatures vary along the well bore, but for most hydrocarbon extraction processes do not exceed about 100° C. However, some hydrocarbons are extracted using thermal recovery techniques. These are applied where the use of heat is useful to reduce the viscosity of the hydrocarbons in the reservoir and assist their release from the geological formation. Such hydrocarbons include bitumens and heavy oils. In thermal recovery applications, not only is it necessary to elevate the temperature, but it is correspondingly necessary to monitor the temperature downhole, in order to determine whether the correct amount of heat is being applied to optimize the recovery operation. Downhole temperature sensing using the distributed temperature monitoring capabilities of an optical fiber, using techniques known in the art, are particularly appropriate in such situations. Accordingly, fiber optic cable 18 shown in FIG. 1 contains one or more optical fibers acting as distributed temperature sensors.

Oil wells using thermal recovery techniques such as steam assisted gravity drainage may use heating applied by means of high temperature steam injected at up to 300° C. In accordance with the invention, degradation of the optical properties in the optical fiber used for temperature monitoring, due to diffusion of hydrogen into the fiber, with consequences ranging from the presence of absorbing peaks due to hydrogen itself to the creation of absorption peaks due to chemical reaction is retarded by electrically isolating the metal control line inside which the optical fibers themselves are deployed. The elevated temperature environments in which the invention is particularly useful are those above 100 or 150° C., and especially those above 200° C.

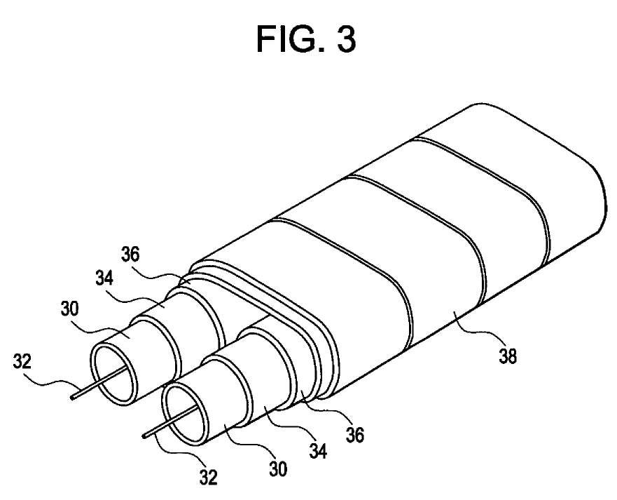

FIG. 2 illustrates a simple optical fiber cable according to the invention. It comprises a metallic control line 20 containing three silica based optical fibers 22 extending through it; the control line is covered with a layer of electrical insulation 24; the electrical insulation is in turn encased in a two component protective sheath comprising firstly a layer 26 of metallic lead, and secondly an outer mechanical armor 28 comprising a steel strap wound helically along and around the core made up of the lead coated, electrically insulated, fiber-containing control line.

The optical fibers 22 in the control line 20 are shown as being three in number. Actual numbers will vary, but there will be at least one fiber forming part of a sensing system. Two or three are typical. The fibers are used as extensive transducers for temperature and pressure monitoring by sending pulses of laser light down the optical fiber from a facility at the surface, and detecting the weakly reflected signals and interpreting them to create a distributed temperature log at, typically, one meter separations along the length of the fiber. For these purposes, the optical fibers are typically based on silica, SiO₂, with or without various dopants. Among the deleterious irreversible changes brought about by hydrogen in silica fibers, the formation of hydroxide species, especially as silicon hydroxide, may in particular be mitigated by the invention.

The fibers are located within control line 20, which is a tube of corrosion resistant metal alloy. A variety of metal compositions may be used, and the latter will be chosen according to the well conditions that are expected. A long life is required. The alloy may be a stainless steel, or an alloy with a higher proportion of nickel, such as Alloy 825 which contains 38-46 weight percent nickel, 19-24 weight percent chromium, and more than 22 weight percent iron, with minor amounts of molybdenum, copper and titanium. The balance is made up of incidental elements below 1 weight percent each, and impurities.

Typical control line dimensions are an overall outside diameter of a quarter of an inch (6.35 mm), with a wall thickness of 1.25 mm. This provides a long lifetime and physical protection of the optical fiber.

The fiber or fibers can be positioned in the tube during manufacture of the tube, after the tube has been formed, or after insulating the tube, or after protecting the tube, but preferably the optical fiber is deployed in the tube after the tube has been formed.

The next layer of the optical fiber cable is electrical insulation 24. The insulating material should remain effective at the temperatures to which the cable is like to be exposed in the environment in which it is to be put to use. A preferred insulating material is EPDM rubber (ethylene propylene diene monomer rubber). Other insulators that may be suitable include paints, varnishes, and in particular numerous families of polymers including polyimides, fluoropolymers including polytetrafluoroethylene and modified ETFE (ethylene-tetrafluoroethylene) polymers, and polyether ether ketones (PEEK). The electrically insulation layer 24 is coated over the tube 20 using techniques appropriate for the particular nature of the insulator, and will typically be applied by an extrusion process. Insulation thicknesses may vary, but from 0.5 to 0.75 mm may be suitable.

The conditions in which the optical fiber cable is to be put to use will influence the design and application of any subsequent layers. As a practical matter, it can be assumed that the electrical insulation 24 will require protection from the environment. This protection might be required to defend the insulating properties against the aggressive actions of fluids in the environment of an oil production well, for example. EPDM rubber is an effective insulator but vulnerable to the effects of hydrocarbons at conventional and elevated temperatures. Furthermore, the electrical insulation should be able to withstand impact and abrasion and other mechanical assaults within a well bore. The fluid resistant sealing layer 26 and mechanical armor 28 form a combination protective sheath for these purposes.

Fluid resistant layer 26 is formed of an extruded layer of lead or a lead alloy. The particular requirement is for integrity of cover to prevent ingress of environmental fluids, in particular to keep the well fluids separated from the insulation. A wide variety of other materials, including metals and polymers, may be used for this purpose. The thickness of sealing layer 26 may suitably be from 0.2 to 1.5 mm, typically from 0.5 to 0.75 mm.

When the insulation layer 24 is protected by a sealing layer 26, the outer mechanical armor 28 more immediately protects the sealing layer rather than the insulation layer. In the case of the sealing layer 26 being of a soft material, such as lead, it is suitably provided with a hard protective outer covering. In the example shown, this covering is provided by a steel strap 28 wound helically along and around the surface of the lead, and succeeding turns of the helically wound strap overlap preceding turns. The strap is preferably shaped with complementary edge portions which inter-engage so that overlapped edges of the helically wound strap are resistant to mutual separation. The strap is preferably a formed metal tape. Other configurations of armor may be used; for example, a narrow elongate strip of metal sheet may folded lengthwise over the sealing layer 26 and its edges seam welded together. Steel is a suitable material for the outer armor, and a corrosion resistant steel or galvanized steel may be chosen. Alternatively, corrosion resistant alloys including Monel metal may be used. Non-metallic materials such as plastics with suitable thermal and mechanical properties may also be used.

FIG. 3 shows a variation in which two control lines 30 each containing one optical fiber 32 are bundled together. Although two lines are shown in the illustration, three or more substantially parallel metal tubes can be bundled together in this manner. Given the great length of the installation, and the fact that the fiber optic cable is not particularly thick, the components are in practice flexible enough to pass through curved sections of a well or bore hole, and thus the tubes are not in this sense always strictly parallel. At least one optical fiber is deployed within each tube.

The tube 30 and fiber 32 correspond to the tube 20 and fiber 22 in FIG. 2. Similarly, in the embodiment shown in FIG. 3 are a layer of electrical insulation 34 covering tube 30, and a first lead layer 36 of a protective sheath encasing the insulation, corresponding to layers 24 and 26 of FIG. 2. These components are substantially identical in the respective optical fiber cables. The difference in the embodiment illustrated in FIG. 3 is that a protective strap 38 is wound along and around the bundle of insulated and sealed tubes, and not around each tube individually. Straps may be wound helically, or in discrete rings, or in longer lengths. Any alternative configuration of protective mechanical armor may also surround the bundle.

It may be convenient to utilize two tubes in a bundle, since this permits the use of a duplex control line extending from a surface termination to a remote location in a bore where a turnaround sub provides a loop connecting the remote ends of the two lines; accordingly, by strapping the two lines together in a bundle with the outer protective strap 38 shown in FIG. 3 the bundle can be treated as a single component, and the two tubes are effectively two branches of one very long U-tube with just two terminal openings at surface level. This arrangement allows deployment of the optical fibers in fluid pumped through the tubes after installation of the bundle in the well.

Reverting to FIG. 1, the fiber optic cable 18 may be as shown in FIG. 2 or FIG. 3 or a further variation. It is clamped against the exterior of production tubing 14 by bands 16, as previously described. Tubing 14 is likely to be steel, possibly a high chromium steel, and by means of the invention the tubing, the clamping bands, and all other metallic components in the vicinity of the cable 18 are kept electrically isolated from the metal of the control line tubes 20, 30 which surrounds the optical fibers 22, 32. While it is true that the outer protective straps 28, 38 are also metallic and in contact with the production tubing, they are separated from the tubes 20, 30 not only by electrical insulation 24, 34 but also by the lead sealing layers 26, 36, and hydrogen arising from electrochemical and other corrosion processes taking place outside these layers are not considered to be significantly detrimental to the optical properties of the internal fibers.

The region of elevated temperature may be of varying length. In portions of the fiber optic cable not expected to be operated in an elevated temperature region, electrical isolation is not required, but may optionally be applied.

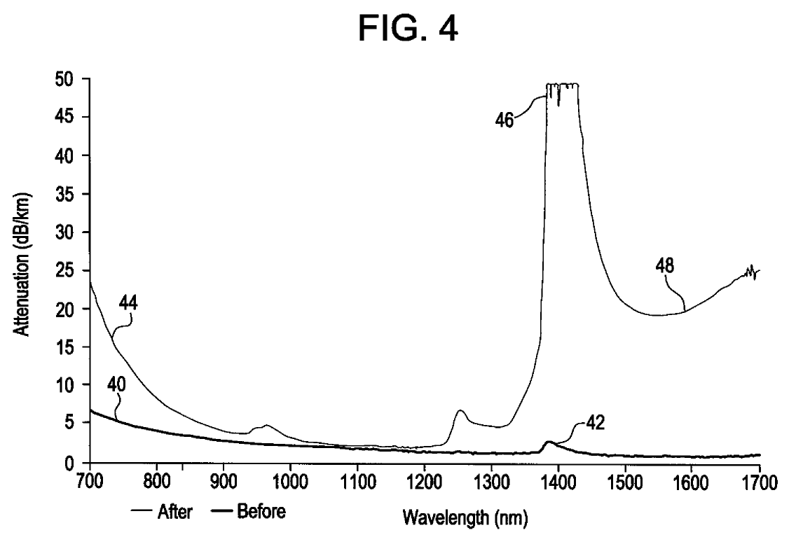

FIG. 4 illustrates a typical aspect of the problem addressed by the invention, and where the benefits lie. Two curves are shown. Each plots light attenuation, expressed in dB per kilometer, against the wavelength of the light, expressed in nanometers. The light is passed along a silica fiber optic cable having a composition, including some dopants having an insignificant effect on attenuation, which is typical of those found in oilfield applications.

The lower curve 40 illustrates the type of attenuation spectrum found in the fiber before deployment. The upper curve 44, on the other hand, is illustrative of the attenuation spectrum that can develop after deployment and operation for several months in a high temperature well, such as an SAGD well operated at around 200° C. The attenuation increase is quite severe (an attenuation of 3 dB means that half the power is lost). Also it can be observed that the attenuation increase is non-uniform with wavelength, creating variation in differential loss over the spectrum. This alone can contribute to the loss of calibration for distributed temperature sensor systems if there is no compensation for differential loss. By means of this invention the development of elevated attenuation levels such as those shown at 44 can be delayed very substantially, allowing considerably longer lifetimes and longer service intervals for the fiber optic cables.

From the foregoing detailed description of specific embodiments of the invention, it should be apparent that a novel and unobvious optical fiber cable and system and method for reducing the rate of optical degradation of an optical fiber has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

1. An optical fiber cable comprising a metal tube; at least one optical fiber deployed within the tube; electrical insulation covering a substantial length of the tube containing the fiber; and a protective sheath over the electrical insulation.

2. An optical fiber cable according to claim 1 wherein said at least one optical fiber is of silica.

3. An optical fiber cable according to claim 1 wherein said at least one optical fiber is part of a sensing system.

4. An optical fiber cable according to claim 3 wherein the sensing system is a system for sensing at least one of temperature, pressure, acoustics and motion.

5. An optical fiber cable according to claim 4 wherein said at least one optical fiber is a distributed temperature sensor.

6. An optical fiber cable according to claim 1 wherein the metal tube is of corrosion resistant alloy.

7. An optical fiber cable according to claim 1 wherein the electrical insulation covering the substantial length of the tube is such as to maintain the electrical insulation of the tube in an elevated temperature environment above 100° C.

8. An optical fiber cable according to claim 7 wherein the electrical insulation covering the substantial length of the tube is such as to maintain the electrical insulation of the tube in an elevated temperature environment above 200° C.

9. An optical fiber cable according to claim 7 wherein the electrical insulation covering the substantial length of the tube is such as to maintain the electrical insulation of the tube in an elevated temperature environment between 150° C. and 300° C.

10. An optical fiber cable according to claim 1 wherein the electrical insulation comprises ethylene propylene diene monomer rubber.

11. An optical fiber cable according to claim 1 wherein the protective sheath comprises a fluid-resistant sealing layer.

12. An optical fiber cable according to claim 11 wherein the sheath comprises a fluid resistant sealing layer over the electrical insulation and a mechanical armor over the sealing layer.

13. An optical fiber cable according to claim 1 wherein the sheath comprises a mechanical armor.

14. An optical fiber cable according to claim 13 wherein the mechanical armor is the outermost layer of the cable.

15. An optical fiber cable according to claim 11 wherein the sealing layer comprises a metal coating over the electrical insulation.

16. An optical fiber cable according to claim 15 wherein the metal coating is selected from lead and lead-based alloys.

17. An optical fiber cable according to claim 16 wherein the metal coating has a thickness from 0.2 to 1.5 mm.

18. An optical fiber cable according to claim 12 wherein the mechanical armor comprises a strap wound helically along and around a core comprising the electrically insulated fiber-containing tube.

19. An optical fiber cable according to claim 18 wherein succeeding turns of the helically wound strap overlap preceding turns.

20. An optical fiber cable according to claim 1 wherein at least a portion of the protective sheath surrounds a length of a second, parallel optical fiber cable comprising a metal tube, at least one optical fiber deployed within the tube, and electrical insulation covering a substantial length of the tube containing the fiber.

21. An optical fiber cable according to claim 20 wherein the said portion of the protective sheath includes a mechanical armor component of the sheath.

22. An optical fiber cable comprising a bundle of substantially parallel metal tubes; at least one optical fiber deployed within each tube; and electrical insulation covering a substantial length of each tube containing said optical fiber.

23. An optical fiber cable according to claim 22 further comprising a protective strap wound helically along and around the bundle.

24. A method of reducing the rate of optical degradation of an optical fiber within a metal tube in an elevated temperature environment, which comprises electrically insulating a region of the tube that is to contain the fiber and to be exposed to elevated temperature; and deploying the fiber in the tube in the elevated temperature environment.

25. A method according to claim 24 wherein the temperature of the elevated temperature environment is greater than 100° C.

26. A method according to claim 24 wherein the temperature in the elevated temperature environment is greater than 200° C.

27. A method according to claim 25 wherein the temperature in the elevated temperature environment is not more than 300° C.

28. A method according to claim 24 comprising the further step of protecting the electrically insulated region of the tube by means of a sheath.

29. A method according to claim 28 wherein the step of protecting the electrically insulated region comprises sealing the electrically insulated region against ingress of environmental fluids.

30. A method according to claim 28 wherein the step of protecting the electrically insulated region comprises extruding a sealing layer of lead or lead alloy over the said region.

31. A method according to claim 28 wherein the step of protecting the electrically insulated region comprises protecting the insulation against mechanical damage.

32. A method according to any one of claim 28 comprising the further step of affixing the insulated and protected tube to a support in the said elevated temperature environment.

33. A method according to claim 32 wherein the support comprises a metallic electrical conductor.

34. A method according to claim 33 wherein the support is a component of a well completion.

35. A method according to claim 24 comprising deploying the optical fiber in the tube after the tube has been formed.

36. A method according to claim 35 comprising deploying the optical fiber in the tube after an external region of the formed tube has been electrically insulated.

37. A method according to claim 36 comprising deploying the optical fiber in the tube after protecting the electrically insulated region of the tube by means of a sheath.

38. A method according to claim 24 comprising deploying the optical fiber in the tube before deploying the tube in the elevated temperature environment.

39. A method according to claim 24 comprising deploying the optical fiber in the tube after deploying the tube in the elevated temperature environment.
